(19) United States
(12) Patent Application Publication
(10) Pub. No.: US 2014/0046742 A1
(43) Pub. Date: Feb. 13, 2014

(54) Systems, Methods and Apparatuses for Rewarding and Ranking Customers, Tracking Customers, Customer Behavior and Customer Activity, and Advance Determination of Customer Demand

(71) Applicant: Neil J. Goodman, Statesville, NC (US)

(72) Inventor: Neil J. Goodman, Statesville, NC (US)

(21) Appl. No.: 14/111,253

(22) PCT Filed: Mar. 11, 2012
(86) PCT No.: PCT/US12/28674

§ 371 Date: Oct. 11, 2013

Related U.S. Application Data
(60) Provisional application No. 61/451,714, filed on Mar. 11, 2011.

(51) Int. Cl. G06Q 30/02

(52) U.S. Cl. CPC G06Q 30/0214
USPC 705/14.16

(57) ABSTRACT

An article of manufacture includes a non-transitory machine-readable medium comprising instructions that, when executed, cause one or more processors to rank a customer in one of multiple tiers of customers based on an amount of rewards assigned to the customer. The one or more processors are further caused to present a first offer during a first time period exclusively to customers ranked in the first tier. The one or more processors are further caused to restrict acceptance of the first offer during the first time period to (a) customers ranked in the first tier and (b) referees referred by any customer ranked in the first tier. Methods and systems for rewarding and ranking customers are also provided.

### CROSS-REFERENCE TO RELATED APPLICATIONS

This application claims the benefit of the filing date of U.S. provisional patent application No. 61/451,714, incorporated herein by reference, which was filed on Mar. 11, 2011, by the same inventor of this application.

### BACKGROUND OF THE INVENTION

1. Field of the Invention

The present disclosure relates in general to systems, methods and apparatuses for rewarding and ranking customers, tracking customers, customer behavior and customer activity, and advance determination of customer demand. More particularly, this disclosure pertains, inter alia, to rewarding and ranking customers, where the rewards may take the form of rights to purchase goods or services, based at least in part on the rankings.

2. Description of the Related Art

E-commerce (e.g., commercial transactions conducted over the Internet) is reaching new heights. E-commerce now accounts for a significant amount of U.S. retail spending. Online sales have increased at a significant rate in recent years, and continue to take market share from traditional (“brick and mortar”) retailers.

Some of the fastest growing areas in e-commerce involve approaches known as group buying and flash sale sites, the latter of which involve limited-time offers. Use of such approaches is often driven by social media sharing, the need to save money, and ease of access to pricing information. These factors enable consumers to find the right deals and to tell others about those deals.

Despite these trends of globalization in commerce, manufacturers, particularly if located remotely from a potential customer base, often do not sell directly to customers, even though elimination of middlemen would be mutually beneficial. Such manufacturers may lack the means to locate and directly connect with customers, to build a customer base, to build a relationship with customers, and to better serve customers by conforming their offerings to customer desires. Obstacles such as distance between buyer and seller and differences between cultures remain a challenge.

Relatedly, with respect to the problems of lack of direct contact and relationship between manufacturers/suppliers/sellers and customers, under current marketing practices, customers may receive offers they have no interest in, but there may be no means to give the uninterested customer an incentive to pass the offer along to someone s/he believes might be interested. While a customer may on occasion make such a referral, the manufacturer/supplier/seller may have no way of knowing that such a referral has taken place and may have no means of identifying such potential new customers, of tracking such referrals, or of tracking and rewarding such customer loyalty.

Further, manufacturers, suppliers and sellers may suffer from not knowing how much of an item to produce or acquire, because, e.g., they may be unable to accurately measure customer demand in advance of production or acquisition. Consequently, it is often the case that excess items are produced and acquired. Such excess often results in waste, i.e., when the items cannot be sold, or at least in extra overhead costs due to excess inventory; in either event, additional costs are incurred by manufacturers, suppliers and sellers, and these additional costs may also be passed onto consumers in the form of increased prices.

It would be useful to have improved systems, methods and apparatuses that would address these problems while meshing with and leveraging the above-mentioned trends.

### SUMMARY OF THE INVENTION

In view of the aforementioned problems and trends, embodiments of the present invention provide systems, methods and apparatuses for tracking customers, customer behavior and customer activity (e.g., customer purchases and referrals), building customer bases and customer relationships, identifying potential new customers, ranking and rewarding customers (implementing customer loyalty programs), and advance determining, measuring, and predicting of consumer demand.

According to a first aspect of the invention, there is provided a customer rewards and ranking system or apparatus, comprising a server, the server comprising a processor and a management application executable by the processor. The management application comprises a rewards module, configured to assign a reward (a) to a customer, based on an action performed by the customer or by a referee referred by the customer, or (b) to a referee referred by a customer, based on an action performed by the referee referred by the customer; a ranking module configured to rank a customer in one of multiple tiers based on an amount of rewards assigned to the customer, the multiple tiers comprising at least a first tier corresponding to a greater amount of rewards and a second tier corresponding to a lesser amounts of rewards; an offer generation module, configured to generate a first offer to sell a good or service for a first price during a first time period, contingent upon a first quantity of the good or service being ordered for purchase within the first time period; an offer presentation module, configured to present the generated first offer during the first time period exclusively to customers ranked in the first tier; and an offer completion module, configured to restrict acceptance of the offer during the first time period to (a) customers ranked in the first tier and (b) referees referred by a customer ranked in the first tier.

According to a second aspect of the invention, there is provided a system or apparatus for tracking customer referrals, comprising a server, the server comprising a processor and a management application executable by the processor. The management application, when executed by the processor, is operable to perform operations comprising: presenting an offer to a recipient, the offer having a tracking device that identifies the recipient and that may be forwarded with the offer if the offer is forwarded from the recipient to a referee.

According to a third aspect of the invention, there is provided a system or apparatus for tracking customer activity, comprising a server, the server comprising a processor and a management application executable by the processor. The management application, when executed by the processor, is operable to perform operations comprising: presenting to a first recipient an offer to purchase a gift code for a second recipient; recognizing when the first recipient accepts the offer to buy the gift code for a second recipient; and recognizing the first recipient's identity when the gift code is redeemed by the second recipient.

According to a fourth aspect of the invention, there is provided a system or apparatus for advance determination of customer demand, comprising a server, the server comprising a processor and a management application executable by the processor. The management application comprises an offer generation module configured to set a price for an item to be offered for sale and to generate an offer to sell the item for the set price; an offer presentation module configured to present the generated offer to one or more recipients; an offer completion module, configured to receive acceptances of the offer from recipients or referees to whom the offer was transferred by respective recipients; and a demand determination module configured to determine a consumer demand, based on the received acceptances. Each of the acceptances comprises an order for purchase of a specified quantity of the item.

According to fifth through eighth aspects of the invention, methods corresponding to the first through fourth aspects are provided.

According to ninth through twelfth aspects of the invention, articles of manufacture corresponding to the first through fourth aspects are provided.

Other embodiments are described and claimed.

### BRIEF DESCRIPTION OF DRAWINGS

Features and advantages of the present invention will become apparent from the appended claims, the following detailed description of one or more example embodiments, and the corresponding figures.

FIG. 1 is a block diagram illustrating an example hardware system for ranking and rewarding customers, in accordance with at least one embodiment;

FIG. 2 is a flow chart illustrating an example method for ranking and rewarding customers, in accordance with at least one embodiment;

FIG. 3 is a flow chart illustrating another example method for ranking and rewarding customers, in accordance with at least one embodiment;

FIG. 4 is a flow chart illustrating an optional portion of an example method for ranking and rewarding customers, in accordance with at least one embodiment;

FIG. 5 is a flow chart illustrating an optional portion of an example method for ranking and rewarding customers, in accordance with at least one embodiment;

FIG. 6 is a flow chart illustrating an optional portion of an example method for ranking and rewarding customers, in accordance with at least one embodiment;

FIG. 7 is a flow chart illustrating an optional portion of an example method for ranking and rewarding customers, in accordance with at least one embodiment;

FIG. 8 is a block diagram of an example communication framework for rewarding customers, where the rewards may take the form of rights to buy goods or services, in accordance with at least one embodiment;

FIG. 9 is a flow chart illustrating an optional social media linking portion of an example method for ranking and rewarding customers, in accordance with at least one embodiment;

FIG. 10 is a flow chart illustrating an optional portion of an example method for ranking and rewarding customers, in accordance with at least one embodiment;

FIG. 11 is a flow chart illustrating an optional portion of an example method for ranking and rewarding customers, in accordance with at least one embodiment;

FIG. 12 is a flow chart illustrating an example method for advance determination of demand, in accordance with at least one embodiment;

FIG. 13 is a flow chart illustrating an example method for tracking customer referrals, in accordance with at least one embodiment; and

FIG. 14 is a flow chart illustrating an example method for tracking customer activity, in accordance with at least one embodiment.

### DETAILED DESCRIPTION OF ONE OR MORE EMBODIMENTS

The foregoing description of the figures is provided for the convenience of the reader. It should be understood, however, that the embodiments are not limited to the precise arrangements and configurations shown. Also, the figures are not necessarily drawn to scale, and certain features may be shown exaggerated in scale or in generalized or schematic form, in the interest of clarity and conciseness. The same or similar parts may be marked with the same or similar reference numerals.

Although the design and use of various embodiments are discussed in detail below, it should be appreciated that the present invention provides many inventive concepts that may be embodied in a wide variety of contexts. The specific aspects discussed herein are merely illustrative of ways to make and use one or more example embodiments of the invention. These example embodiments are not intended to limit the scope of the invention, as it would be impossible or impractical to include all of the possible embodiments and contexts of the invention in this disclosure. Upon reading this disclosure, many alternative embodiments of the present invention will be apparent to persons of ordinary skill in the art.

Embodiments of the present invention have been conceived and developed to address the aforementioned problems in light of, and so as to mesh with and leverage, current market and social trends, such as increased use of e-commerce, group buying, flash sales, and social media, as well as a globalized commercial system. Even today, manufacturers and suppliers suffer from the difficulties of distance, culture and lack of technology to establish direct contact with customers and to track, reward and leverage customer relationships and referrals. These problems are especially difficult for small merchants, manufacturers and suppliers. While not so limited, the present disclosure may be beneficially applied to large markets such as the United States, being supplied directly from remote locations, which may include foreign countries such as China (e.g., directly from the factory) and hence may provide customers with a wider range of options to meet their consumption requirements and may also enable those customers to avoid certain cost layers. The present disclosure could also facilitate customers in other countries buying from suppliers in locations remote from those countries, such as customers in China buying from suppliers in North or South America, Europe or Australia, to mention just a few examples.

The present disclosure introduces systems, methods and apparatuses for tracking customers, customer behavior, and customer activity (e.g., customer purchases and referrals), building customer bases and customer relationships, identifying potential new customers, ranking customers and creating, managing and implementing customer rewards, including rights to purchase, and advance determining, measuring, and predicting of consumer demand.

As an example, according to embodiments set forth herein, not only may purchases by customers be tracked and rewarded, but referrals from one customer to another potential customer (“referee”) may be tracked and rewarded. Thus, such relationships may be leveraged to identify potential new customers and to build a manufacturer's/supplier's/seller's customer base.

For another example, some big box retailers claim to buy directly from foreign countries such as China, but they typically do not actually circumvent all of the cost layers between the factories and the end consumers. Thus, cost layers such as sourcing expenses, brokers/agents, corporate bureaucracy, stores and distribution centers, inventory carrying costs, and dead inventory may remain. Even for domestic retail outlets that obtain products at low cost from outside of the United States, the biggest three expense categories are typically employees, inventory, and facilities (or “bricks and mortar”). Accordingly, years into the “China Price” era, consumers typically still pay much more than the real China price. In other words, despite the global commercial system, e-commerce, etc., consumers are still not getting the full benefit such factors can provide. For example, customers are still bearing costs associated with cost layers such as sourcing expenses, brokers/agents, corporate bureaucracy, stores and distribution centers, inventory carrying costs, and dead inventory. One way to eliminate or reduce some of these costs would be by manufacturers, suppliers and/or sellers being able to accurately determine, measure or predict consumer demand before production or acquisition is commenced or before production or acquisition is completed. This could reduce the amount of excess (unsellable) stock produced and inventory held. This ability to gauge consumer demand in advance is provided by aspects of the systems, methods and apparatuses set forth herein.

Consequently, the systems, methods and apparatuses set forth herein may benefit consumers by facilitating suppliers in offering very low price points, for very high quality goods, e.g., offering goods of higher quality than those typically found at big box retailers, yet for significantly less money. This may generate a snowball effect, as the high quality, low cost goods may generate tremendous online chatter and sharing, causing greater consumer participation, which in turn facilitates suppliers being able to offer high quality goods at low prices.

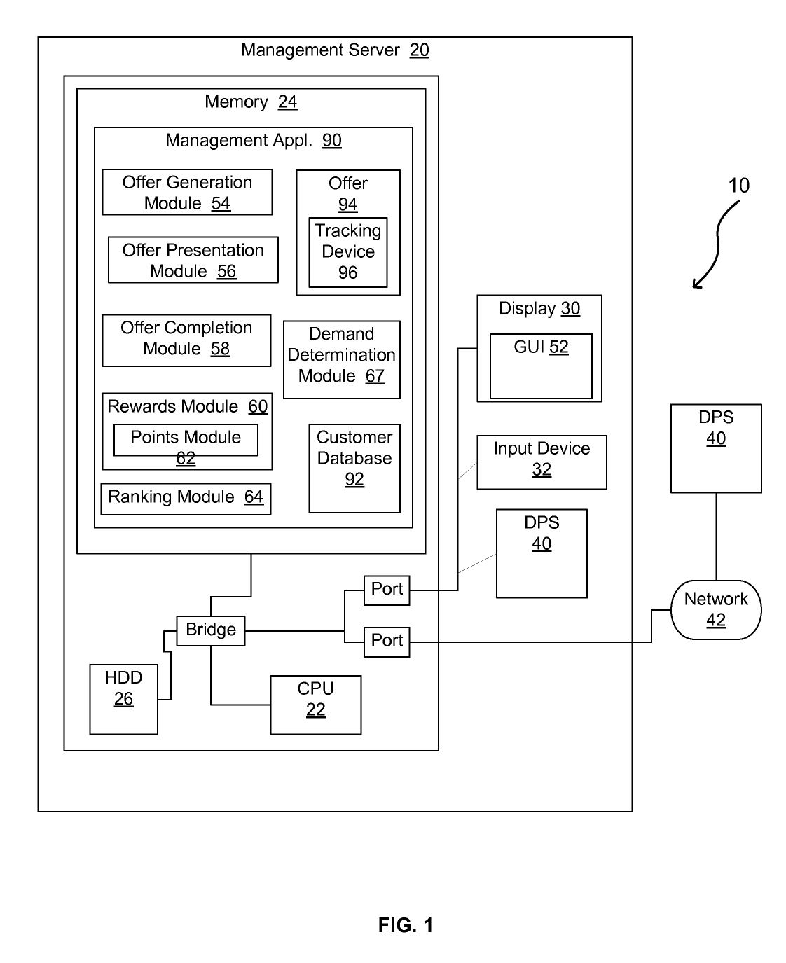

FIG. 1 is a block diagram illustrating an example hardware system and apparatus for rewarding and ranking customers, tracking customers, customer behavior and customer activity, identifying potential new customers, building customer bases, and advance determination of customer demand, in accordance with at least one embodiment. As shown in FIG. 1, a management application 90 may execute on a management server 20. Management server 20 may include various hardware resources, such as at least one central processing unit (CPU) 22 (which may also be referred to as a processor), memory 24, a hard disk drive 26, one or more bridges for communications between different hardware components, and one or more input/output (I/O) ports for communications with external devices such as a display 30 (which may have a graphical user interface 52) and a keyboard, a mouse, and/or other input devices 32. As illustrated in FIG. 1, memory 24 is accessible to CPU 22, and memory 24 may store management application 90. Alternatively, memory 24 may store a portion of management application 90, a portion being stored elsewhere, or management application 90 may be stored entirely outside of memory 24, with any portion of management application 90 stored outside of memory 24 still being accessible to CPU 22. Management server 20 may include a data processing system 40 and/or may communicate with a remote data processing system 40 via a network port and one or more networks 42, such as the Internet. Data processing system(s) 40 may provide data processing functions in support of the operations described herein, as will be understood by one of ordinary skill in the art. When cooperating to provide the functionality described herein, management server 20 and data processing system(s) 40 may be referred to collectively as a management system 10. However, management system 10 may also be deemed to include management server 20 without a data processing system 40.

Management application 90 may include various components, such as a rewards module 60, a points module 62, which may be a portion of rewards module 60, a ranking module 64, an offer generation module 54, an offer presentation module 56, an offer completion module 58, a demand determination module 67, and a customer database 92. Management application 90 may be used to create or define an offer 94, and to present offer 94 to multiple customers. Offer may contain a tracking device 96, for tracking and identifying a recipient of an offer and/or a referee of an offer, i.e., one to whom an offer is referred by a recipient (one example of a tracking device is a key or token, discussed below). Rewards module 60 may be configured to assign rewards to customers and referees, based on an action performed by one of them. Points module 62 may be configure to assign points to customers, corresponding to or representing the rewards. Ranking module 64 may be configured to rank customers based on amounts of rewards that have been assigned to customers. Offer generation module 54 may be configured to create or define an offer, e.g., setting various parameters that define an offer, as discussed below, for example, with reference to Equations (1), (2) and (3). Offer presentation module 56 may be configured to present an offer to multiple recipients. Offer completion module 58 may be configured to receive acceptances of offers, and to (determine whether to) permit or not permit an offer to be accepted by a given recipient, depending on the rank of the given recipient, as explained further below. Demand determination module 67 may be configured to determine a quantity of an item ordered for purchase and a consumer demand for an item, based on the quantity ordered for purchase; and to inform a provider of an item of a determined demand for an item, and to notify a provider of an item to commence or complete production of the item, according to the determined demand. Customer database 92 may contain data on customers, referees, purchasers, potential customers, etc. Further description of these components and these and other operations performed by these components will be provided below.

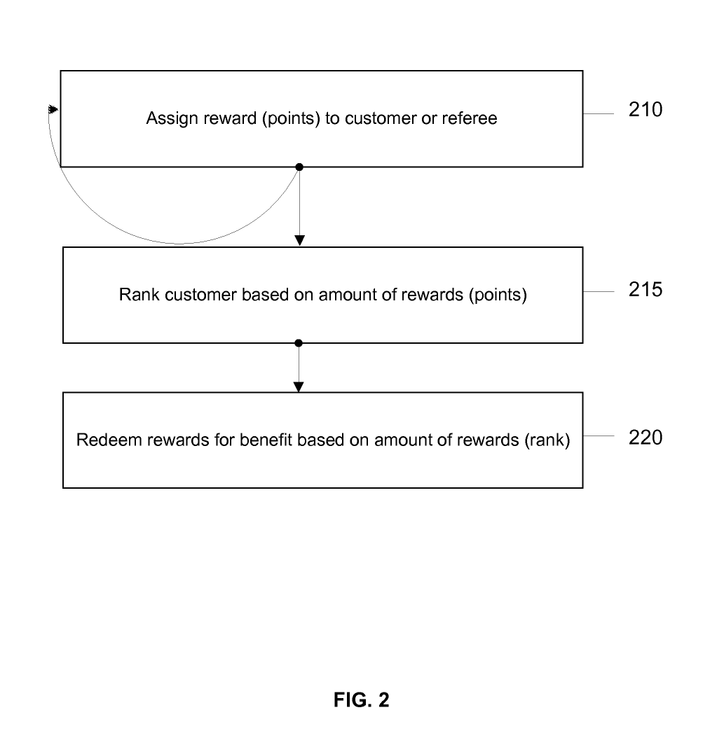

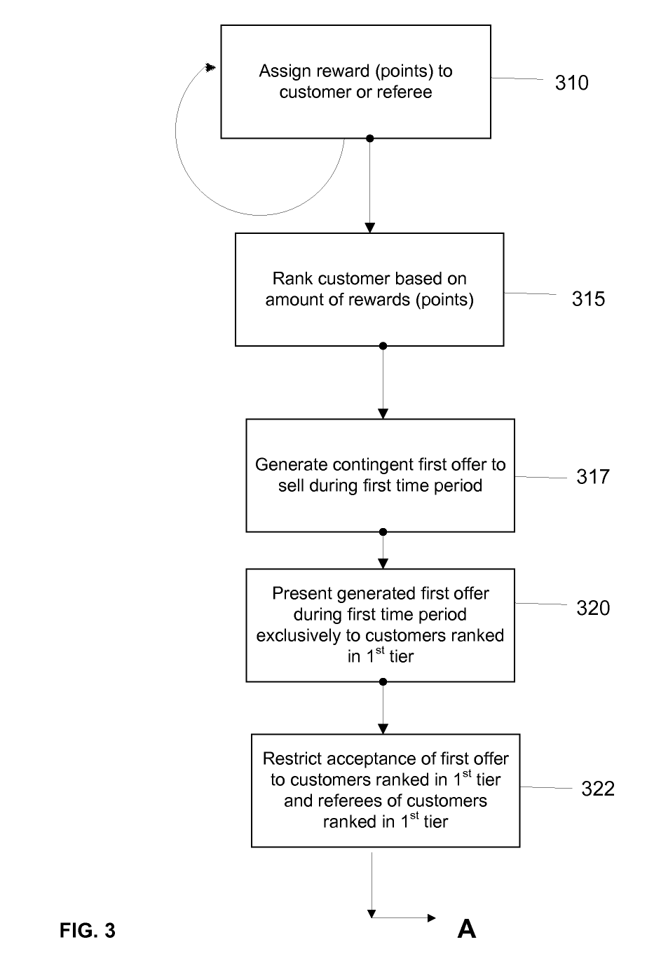

FIG. 2 is a flow chart illustrating an example method for ranking and rewarding customers, in accordance with at least one embodiment. The method may be performed by management application 90 (which includes various modules, as discussed above) executed on server 20 by CPU 22. As shown in FIG. 2, at step 210 rewards module 60 assigns a reward (a) to a customer, based on an action performed by the customer or by a referee referred by the customer, or (b) to a referee referred by a customer, based on an action performed by the referee referred by the customer. It may be noted that customers and referees may be individuals, groups of individuals, or entities (for the sake of convenience, the discussion herein may refer only to one such term, such as individuals or the like, but it should be understood that the other terms, in this case groups and entities, are also included). (The notion of “points” referenced in step 210 will be explained below.) As represented by the feedback loop in the figure, step 210 may occur multiple times, based on multiple actions, such that a customer or referee may be assigned multiple rewards, which accumulate and may be referred to as the customer's or referee's amount of rewards. In step 210, where the reward is assigned (a) to a customer, the action performed by the customer may be a purchase, a referral of a referee, or another action, and where the reward is assigned (b) to a referee, the action performed by the referee may be a purchase or another action. At step 215, ranking module 64 ranks the customer in one of multiple tiers based on the amount of rewards assigned to the customer. The multiple tiers may include at least a first tier corresponding to a greater amount of rewards and a second tier corresponding to a lesser amount of rewards. Additional tiers may be included. At step 220, management application 90 permits rewards to be redeemed for benefits. In this regard, different customers or referees may obtain different benefits depending on the amount of rewards they have accumulated. Inasmuch as the amount of rewards accumulated by a customer corresponds to the customer's rank, a customer may be eligible for different benefits according to his or her amount of rewards or rank. The benefits may be money, prizes, special buying opportunities, or any other benefits. The case in which the benefit is a special buying opportunity is encompassed by FIG. 2 and the discussion thereof but specific versions of this case will be described in the following discussion with reference to FIG. 3 and other figures as referenced below.

FIG. 3 is a flow chart illustrating an example method for ranking and rewarding customers, in accordance with at least one embodiment. The method may be performed by management application 90 executed on server 20 by CPU 22. As shown in FIG. 3, at step 310 rewards module 60 assigns a reward (a) to a customer, based on an action performed by the customer or by a referee referred by the customer, or (b) to a referee referred by a customer, based on an action performed by the referee referred by the customer. (The notion of “points” referenced in step 310 will be explained below.) As indicated by the feedback loop in the figure, step 310 may occur multiple times, based on multiple actions, such that a customer or referee may be assigned multiple rewards, which accumulate and may be referred to as the customer's or referee's amount of rewards. In step 310, where the reward is assigned (a) to a customer, the action performed by the customer may be a purchase or a referral of a referee, and where the reward is assigned (b) to a referee, the action performed by the referee may be a purchase. Alternatively, in either case, the action may be another action. At step 315, ranking module 64 ranks the customer in one of multiple tiers based on the amount of rewards assigned to the customer. The multiple tiers may include at least a first tier corresponding to a greater amount of rewards and a second tier corresponding to a lesser amount of rewards. Additional tiers may be included. Customer rank information may be stored, e.g., in customer database 92. At step 317, offer generation module 54 generates a first offer to sell a good or service for a first price during a first time period, contingent upon a first quantity of the good or service being ordered for purchase within the first time period. At step 320, offer presentation module 56 presents the generated first offer during the first time period exclusively to customers ranked in the first tier. (Various expressions may be used interchangeably with “present an offer,” such as “proffer an offer,” “extend an offer,” “issue an offer,” etc.; an individual, group or entity to whom an offer is presented may be referred to as a recipient, profferee, etc.) Offer presentation module 56 may obtain the required customer data (regarding customers ranked in the first tier) from customer database 92. It should be noted that management application 90 may indeed make the first offer known to individuals other than customers ranked in the first tier, but according to this embodiment the first offer would not be presented for acceptance to such others, i.e., such others would not be eligible to accept the first offer. When an individual makes an attempt to accept the first offer, offer completion module 58 determines whether the individual is a customer ranked in the first tier or a referee referred by a customer ranked in the first tier. In making this determination, offer completion module 58 may use information stored in customer database 92. If the individual attempting to accept the first offer is a customer ranked in the first tier or a referee referred by a customer ranked in the first tier, then offer completion module 58 permits the first offer to be accepted; if not, then offer completion module 58 does not permit the offer to be accepted. In other words, as illustrated at step 322, offer completion module 58 restricts acceptance of the first offer during the first time period to customers ranked in the first tier and referees referred by a customer ranked in the first tier.

Thus, for the case of FIG. 3, that is, the case where the reward is redeemable for a special buying opportunity, the offer to sell may be described as conditional, contingent, constrained, limited, qualified or by a like descriptive term, as stated (these descriptive terms will be used interchangeably unless otherwise noted). Elaborating on this point, the offer may be understood as contingent upon a number of conditions or, put in another way, as a function of a number of factors, parameters, or variables, which define the offer. This functional conception of the offer is set forth in Equation (1).

O=f(I,P,T,Q) (1)

where I is the item, that is, the good or service being offered for sale, P is the price at which the item is being offered for sale, T is the time period during which the item is being offered for sale, and Q is the minimum quantity of the item that must be ordered for purchase within time period T in order for the sale to go through. (It is acknowledged that, for example, the item I may be understood to be a more fundamental or constitutive aspect of the offer rather than merely a “condition” of the offer; in this regard, the functional conception of the offer set forth here is presented merely as a heuristic device and is not intended as making any assertion about the nature or character of the entities (viz., item, price, time period, quantity) indicated as the parameters of the offer.) Where the minimum quantity Q is not ordered within time period T, the offer may be understood as having never been made because one of the conditions of the offer was never fulfilled. Whereas the discussion of FIG. 3 above speaks of a “first price,” “first time period,” and “first quantity,” Equation (1) illustrates the simplest case of FIG. 3, that is, where there is only a single price, time period and quantity, or in other words, where the offer is a function of only a single price, time period and quantity. More complicated scenarios, in which the offer(s) is (are) defined in terms of multiple prices, time periods and/or quantities, are described below. It should also be noted that, despite Equation (1), it is possible to create and present an offer defined solely in terms of item I and price P, i.e., where the offer is not subject to any conditions of time period T and minimum quantity Q: in contrast to Equation (1), this scenario could be represented as O=f(I, P). To be sure, however, Equation (1) still accommodates and can represent this scenario in which the offer is not subject to any conditions of time period T and minimum quantity Q. Specifically, the absence of a time period condition is equivalent to the first time period having a beginning point when the offer is presented and having no end point, and the absence of a minimum quantity condition is equivalent to setting Q equal to zero.

With continued reference to Equation (1), from the point of view of a seller, or management application 90 acting on behalf of a seller, an offer is created or generated by setting the various conditions or parameters that define the offer. In the case of management application 90, the offer may be created or generated by offer generation module 54. For example, to create an offer to sell watches, a seller or offer generation module 54 may determine and set the following parameters: a price of $100, a quantity of 100 units, and a time period or deadline of 8 hours from the time management application 90 (offer presentation module 56) issues the offer (the parameter I, in this example watches, having been fixed at the outset).

As mentioned, customers (or referees) may be ranked based on the amount of rewards they have been assigned. According to some embodiments, management application 90 (ranking module 64) may rank customers (or referees) into multiple tiers, based on the respective amounts of rewards assigned to the customers (or referees). The multiple tiers may include a first (highest) tier and one or more other tiers. A_customer's (or referee's) being placed or ranked in a given tier is equivalent to the customer (or referee) having been assigned an amount of rewards exceeding a certain threshold (i.e., a certain specified amount of rewards). (A customer ranked in a certain rank, or equivalently, having an amount of rewards exceeding a certain threshold, may also be referred to and classified as a preferred customer.) A customer (or referee) may be eligible for different benefits, depending on his or her rank or, equivalently, amount of rewards. For example, certain benefits may be made available only to customers (or referees) who have achieved at least a certain minimum rank or, correspondingly, who have accumulated at least a certain minimum amount of rewards.

It is noted that at times, for the sake of convenience, the discussion herein refers to customers rather than both customers and referees. It is to be understood that such references to customers alone are intended to also encompass referees to the extent applicable based on (i.e., consistent with) the portions of the instant application which discuss referees.

Returning to FIG. 1, points module 62 and ranking module 64 will be described according to some embodiments. Points module 62 may be configured to assign a quantity of points to a customer, where the quantity of points to be assigned to the customer comprises the reward to be assigned to the customer. That is, where a customer is due a reward based on an action, the customer will be assigned a quantity of points corresponding to the magnitude of the reward due the customer. Ranking module 64 may be configured to rank the customer based on the number of points assigned to the customer, where the number of points assigned to the customer comprises the amount of rewards given to the customer. That is, the customer may be ranked according to the number of points he or she has been assigned or, equivalently, the amount of rewards accumulated by the customer based on his or her actions. According to some embodiments, in which points module 62 and ranking module 64 are so configured, an example method for ranking and rewarding customers may include the following operations. Points module 62 may assign a quantity of points to the customer, the quantity of points comprising the reward given to the customer, as illustrated, for example, in step 210 of FIG. 2 and step 310 of FIG. 3. Ranking module 64 may rank the customer into one of multiple tiers, based on a number of points assigned to the customer, the number of points comprising an amount of rewards assigned to the customer, as illustrated, for example, in step 215 of FIG. 2 and step 315 of FIG. 3. These rankings may then be used in making benefits available to customers, as illustrated, for example, in step 220 of FIG. 2 and step 320 of FIG. 3.

Specific illustrative, non-limiting examples of portions or aspects of the customer rewards and ranking systems and methods described above, including in some cases points module 62 and ranking module 64, will now be related. In at least one embodiment, customers earn points from management application 90 in two ways: (a) by personally buying goods or services through management application 90, and (b) by referring an offer from management application 90 to somebody else (a “referee”), who buys the good or service. In at least one embodiment, both the original customer (the “referrer”) and the referee earn points when the referee purchases goods or services from a referred offer. For example, if a customer buys a watch for $100 from management application 90, points module 62 may award X points to the customer. If the customer instead forwards the offer to a friend who buys the watch for $100, points module 62 awards X points to the friend for purchasing the item and Y points to the person who forwarded the offer. In at least one embodiment, X may equal Y (e.g., the referrer and the referee may both get 100 points). In at least another embodiment, the referrer may get more or fewer points than the purchaser/referee. Furthermore, in at least one embodiment, management application 90 may award points to a referrer for simply making a referral, even if the referee does not accept the offer. Accordingly, the term “referee” applies to the person, group, or entity referred by the customer, regardless of whether or not that person, group or entity makes a purchase.

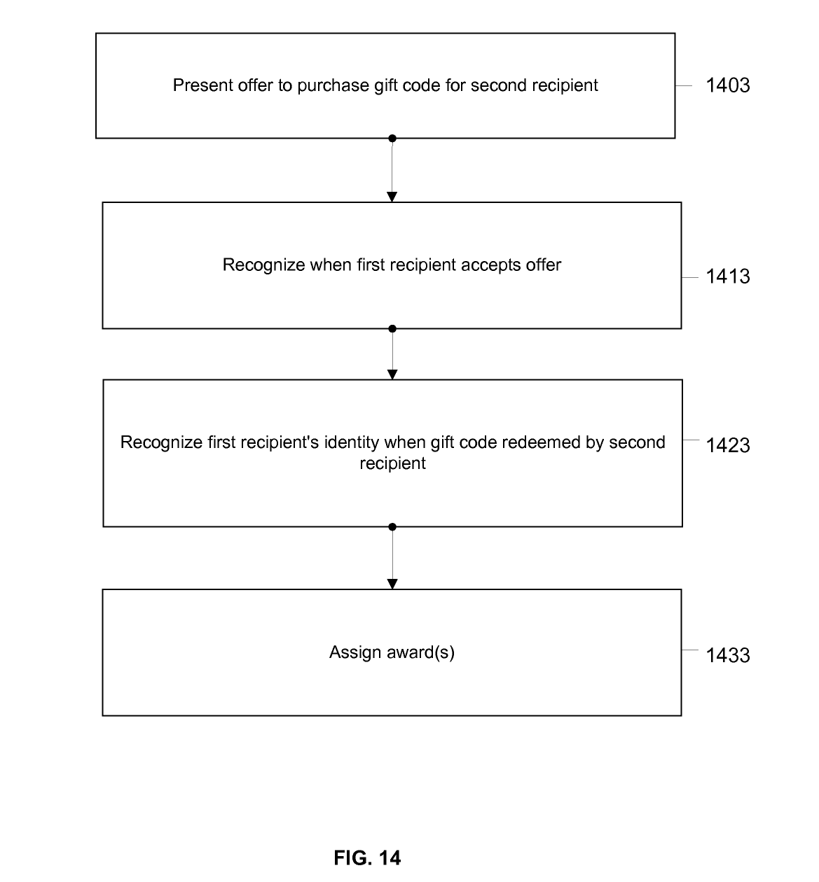

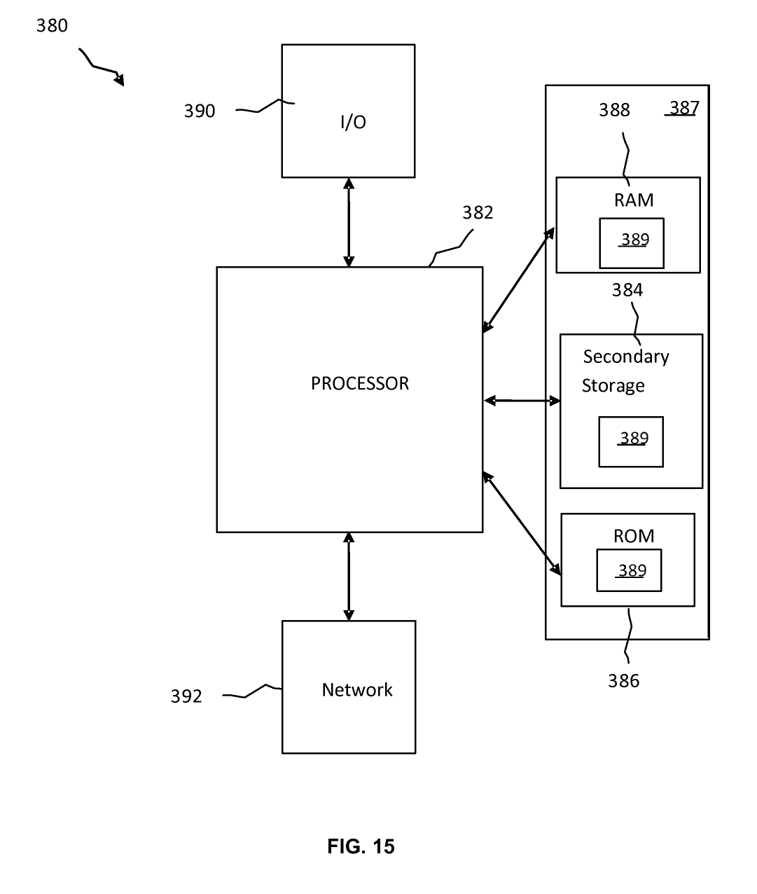

Another possible implementation of a way in which points (rewards) may be obtained is a feature whereby gifts may be purchased and passed on to others, and both the purchaser and the recipient get credit. For instance, the management application may allow members to buy gift cards/codes. In this regard, the management application may award points (a reward) (a) to the buyer of the gift code when it is purchased, (b) to the recipient when he or she redeems the gift code, and (c) to the buyer when the recipient redeems the gift code, or any combination of such rewards. An example of this implementation is the method illustrated in FIG. 14. As seen in the figure, at step 1403, management application 90 presents to a first recipient an offer to purchase a gift code for a second recipient. At step 1413, management application 90 recognizes when the first recipient accepts the offer to buy the gift code for a second recipient. At step 1423, management application 90 recognizes the first recipient's identity when the gift code is redeemed by the second recipient. At optional step 1433, management application 90 assigns reward(s). Specifically, management application 90 may assign a reward to the first recipient based on the first recipient's purchase of the gift code; and/or management application 90 may assign a reward based on the second recipient's redemption of the gift code, to the first recipient and/or the second recipient. Management application 90 may assign any combination of such awards.

According to at least one embodiment, ranking module 64 may sort the customers by points earned, thus ranking customers according to how much product they have purchased. Points earned from other activities, such as referrals, may also feed in to the ranking Ranking module 64 may rank customers into multiple tiers, based on the number of points, or amount of rewards, assigned to the customers. Thus, the customer's being placed or ranked in a given tier corresponds to the customer having been assigned a number of points, or an amount of rewards, exceeding a certain threshold. The multiple tiers may include a first (highest) tier and one or more other tiers.

According to some embodiments, higher ranking customers are given preference in obtaining benefits based on their rewards. In some cases, this preference could be that certain benefits are made available only to customers having a certain minimum rank or amount of rewards. In some cases, this preference could be that certain benefits are made available only to customers having a certain minimum rank or amount of rewards, and certain lesser benefits are made available to customers having a certain lower minimum rank or amount of rewards. In some cases, more than two successive levels of benefits could be made available to more than two successive tiers or tranches of customers. In some cases, the benefits could be special buying opportunities, and the lesser benefits could be less desirable buying opportunities (e.g., to buy at a higher price, or at a later time, or with less chance of being able to realize the opportunity). For the cases in which different levels of benefits are available to different levels (ranks) of customers, the functional conception of offer explained above may be revised to reflect the fact that the offer may be defined in terms of multiple time periods and in some cases multiple prices and/or multiple minimum quantities. Equation (2) shows this revised and more complex formulation of the offer.

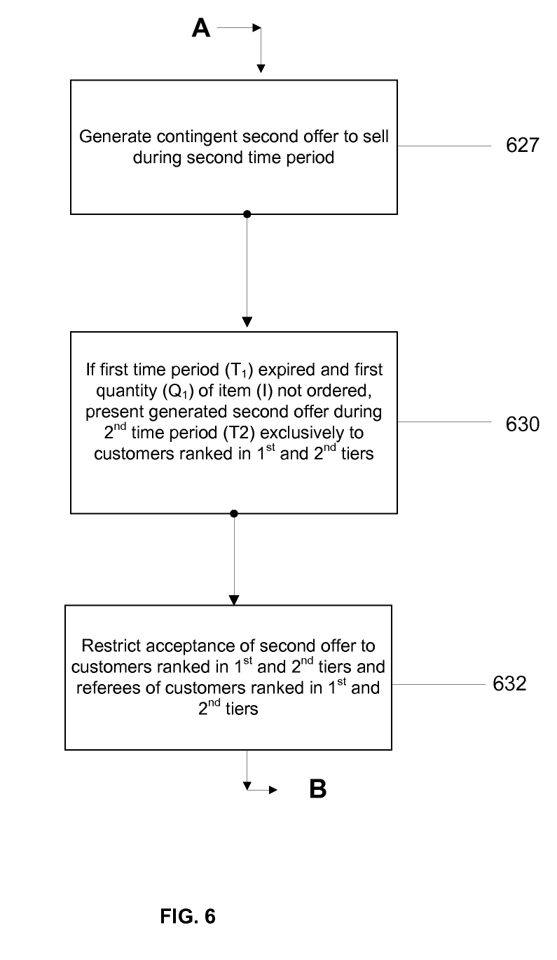

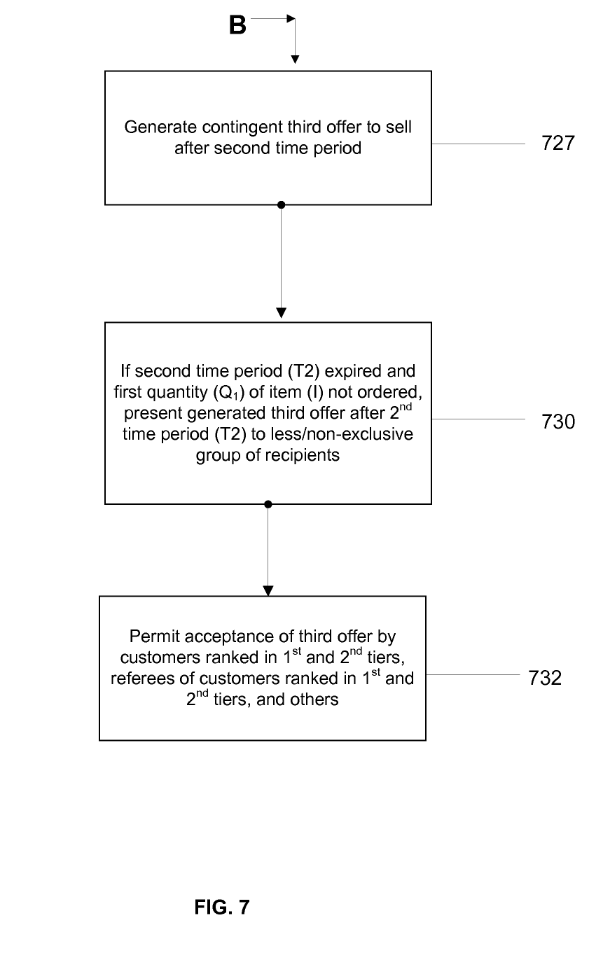

O=f(I,P1{ . . . PN},T1{ . . . TN},Q1{ . . . QN}) (2)

where I is the item, that is, the good or service being offered for sale, P1 to PN are the one or more prices at which the item is being offered for sale during different time periods, T1 to TN are the one or more time periods during which the item is being offered for sale, and Q1 to QN are the one or more minimum quantities of the item that must be ordered for purchase within respective time periods. In the equation, the curly braces around the expressions “ . . . PN,” “ . . . TN,” and “ . . . QN” indicate that the offer may be a function of one or more prices/times/quantities; it is not necessarily the case that the offer be defined in terms of multiple prices/times/quantities. Customer rewards and ranking systems and methods exemplifying more complicated preference based on ranking are now described with reference to FIGS. 5, 6 and 7. It is noted that each of FIGS. 5 and 6 may be deemed to be an optional extension of FIG. 3, and FIG. 7 may be deemed to be an optional extension of FIG. 6 (with qualifications noted below).

Turning to FIG. 5, in step 527 (shown as next in the flow after step 322 of FIG. 3), offer generation module 54 generates a second offer to sell the good or service for a second price after expiration of the first time period. (That is, the second offer is an offer to sell during a time period following the first time period; of course, the offer may be generated before expiration of the first time period and prior to step 322, but the second offer would not be presented until the first time period has expired.) In step 530, offer presentation module 56 presents the generated second offer after expiration of the first time period to one or more recipients. In this regard, the second price may be a higher price than the first price, which was in effect during the first time period (see discussion of step 320 above). Further, in step 530 presentation and acceptance of the offer may not be so restricted as was the case in step 320 as described above (i.e., first offer was presented only to customers ranked in the first tier, and acceptance was restricted to customers in the first tier and referees referred by a customer ranked in the first tier); it may or may not be so restricted, it may be more restricted or less restricted, or it may be totally unrestricted (i.e., open to the public).

Turning to FIG. 6, at step 627 (shown as next in the flow after step 322 of FIG. 3), offer generation module 54 generates a second offer to sell the good or service for the first price during a second time period, subsequent to the first time period, contingent upon the first quantity of the good or service being ordered for purchase within the second time period. (Of course, the generation of the second offer may be carried out prior to expiration of the first time period and prior to step 322, but the second offer would not be presented until the second time period has begun.) At step 630, offer presentation module 56 presents the generated second offer during the second time period exclusively to customers ranked in the first or second tier, if the first time period has expired and the first quantity of the good or service was not ordered for purchase within the first time period. When an individual makes an attempt to accept the second offer, offer completion module 58 determines whether the individual is a customer ranked in the first or second tier or a referee referred by a customer ranked in the first or second tier. In making this determination, offer completion module 58 may use information stored in customer database 92. If the individual attempting to accept the first offer is a customer ranked in the first or second tier or a referee referred by a customer ranked in the first or second tier, then offer completion module 58 permits the first offer to be accepted; if not, then offer completion module 58 does not permit the offer to be accepted. In other words, as illustrated at step 632, offer completion module 58 restricts acceptance of the second offer during the second time period to customers ranked in the first or second tier and referees referred by a customer ranked in the first or second tier.

Turning to FIG. 7, at step 727 (shown as next in the flow after step 632 of FIG. 6), offer generation module 54 generates a third offer to sell the good or service for the first price after expiration of the second time period, contingent upon the first quantity of the good or service being ordered for purchase. (Of course, the generation of the third offer may be carried out prior to expiration of the second time period and prior to step 632, but the third offer would not be presented until the second time period has expired.) At step 730, offer presentation module 56 presents the generated third offer to one or more recipients, if the second time period has expired and the first quantity of the good or service was not ordered for purchase within the second time period. At step 732, offer completion module 58 permits the third offer to be accepted after expiration of the second time period by (1) customers ranked in the first or second tier, (2) referees referred by a customer ranked in the first or second tier, and (3) recipients other than (A) customers ranked in the first or second tier and (B) referees referred by a customer ranked in the first or second tier. It may be noted that this formulation of step 732 does not specify definitively whether step 732 imposes any limit on the group of individuals whose offers will be accepted: the group labeled (3) may be all-inclusive (i.e., including all recipients other than (A) and (B)) or limited (i.e., including only some recipients other than (A) and (B)).

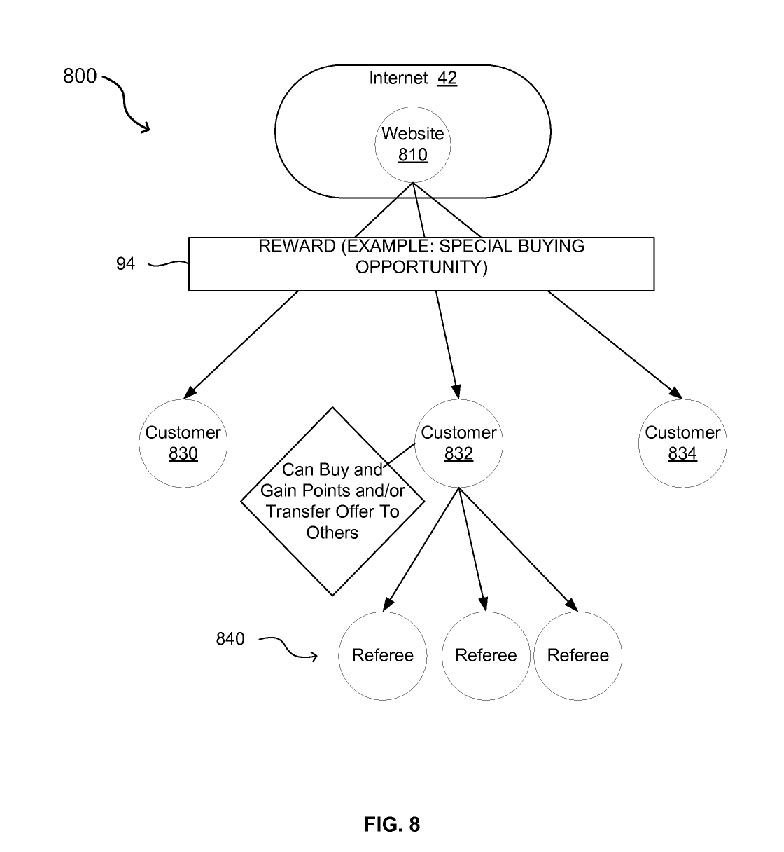

FIG. 8 is a block diagram of an example communication framework 800 for rewarding customers, where the rewards may take the form of rights to buy goods or services, in accordance with at least one embodiment. Specific, non-limiting examples of portions or aspects of the customer rewards and ranking systems and methods set forth above will now be related. In some embodiments, management application 90 presents offers to the highest ranking customers first. For instance, as illustrated in FIG. 8, management application 90 may use email to send an offer 94 to the selected customers 830, 832, 834. The interested customers may then visit a website 810 for management application 90 to accept the offer. Alternatively, as shown by the arrows connecting customer 832 with other recipients 840, one or more customers may decide to forward the offer to others (referees), such as friends, family members, colleagues, etc. Although FIG. 8 refers to customers, friends, etc., it should be understood that the actual electronic communications may be sent to electronic devices (e.g., personal computing devices, mobile or handheld devices, etc.) associated with those customers, friends, etc. Management application 90, or more specifically, offer presentation module 56, may present an offer to a customer or other recipient by transmission to an electronic device, e.g., associated with the customer or other recipient. For instance, a customer may receive an offer via email on a laptop computer, and that customer may then forward the offer to a friend, who receives it via email on a smartphone. Other means for issuing offers or extending invitations include, without limitation, text messages, Facebook™ messages, Twitter Tweets™, etc.

For a predetermined amount of time after sending the original offer, management application 90 may only allow purchases by the specific customers to whom the offer was originally presented, or to referees of those customers. Thus, management application 90 may only bestow the “right to buy” to customers who have sufficient points, and management application 90 may allow those customers to transfer that right to a referee.

However, if the offer is not sold out within a predetermined period of time, management application 90 may present the offer, in a succession of subsequent sets of emails, to tranches of customers with progressively lower rankings. Eventually, if the offer is not sold out, management application 90 may open it up to members with zero points, or even directly to the general public (although registration may be required for such an offer to be accepted, as indicated below).

As has been mentioned, according to various embodiments, an offer may be forwarded or transferred (the terms are used interchangeably) to another. Terminological details as well as specific, non-limiting examples of such transferring will now be related.

Instead of being called a referrer, a member who receives an offer and forwards it to one or more other people may also be called a host. Forwarded offers may be called invitations. And the people who receive such invitations may be called invitees. In one embodiment, invitations may be sent to people who are members and people who are not members, but an invitee must become a member (e.g., by following a simple registration process) before the invitee can accept the offer.

For instance, management application 90 may create offers to sell 100 grandfather clocks at $500 a piece, and management application 90 may send those offers to the top 1000 members, based on the points that have been assigned to those customers. When Adam, as one of the top 1000 members, receives one of those offers, he may decide not to accept the offer (i.e., not to buy the product that is being offered for sale) but instead to forward the offer to Bob. Any suitable means may be used to forward the offer to Bob. For instance, Adam may simply forward the email message to Bob, Adam may enter Bob's email address at a website for the sale management application, Adam may send Bob a text with a URL that will allow Bob to accept the offer over the Internet, etc. Even if the email does not come straight from Adam to Bob, Adam's email address may be used as the “sender,” so that Bob will easily understand that the offer was forwarded by Adam.

As an alternative to forwarding an offer to a referee, the customer may purchase on behalf of another (e.g., members can have products delivered to a different “ship to” address).

In at least one embodiment, management application 90 limits the number of invitations that can be sent by any particular member for any particular offer, and management application 90 does not allow invitations to be sent by anyone other than those members who received the original offer. For example, management application 90 may only allow Adam to forward the invitation to 10 other people, and management application 90 may not allow Bob (or any other invitees) to forward the invitation to anyone else.

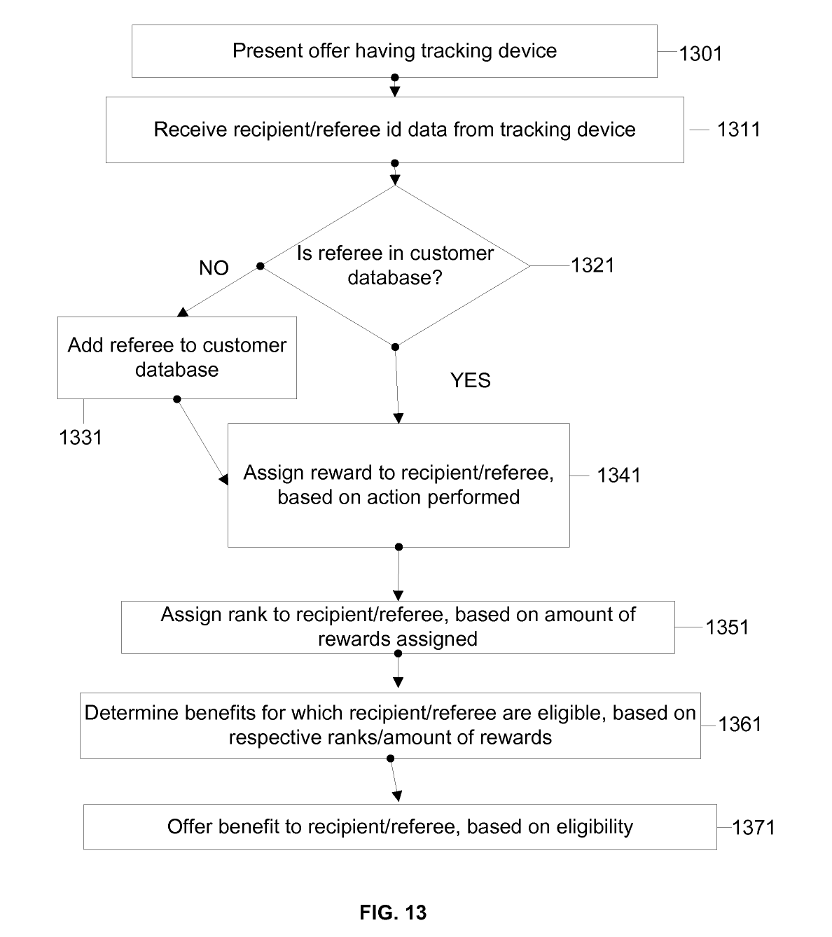

When Bob receives the invitation, he may activate a hyperlink in the invitation to accept the offer if he wants to buy one (or more) of the grandfather clocks. The hyperlink may take Bob to a website that prompts him to register as a member, if he is not already so registered. The website may also allow Bob to accept the offer. In addition, the invitation may include a visible or invisible key or token that links the invitation with the host who sent it, so management application 90 can automatically determine to whom points should be awarded. This arrangement (linking by key or token) is further described with reference to FIG. 13, discussed below.

In another embodiment, management application 90 allows referrers to refer offers to an unlimited number of referees. Management application 90 may allow the proprietor to set different referral limits (possibly including no limit) for different offers. Management application 90 may also allow a person to opt out altogether, to prevent any members from using management application 90 to send any referrals to the person who has opted out.

As discussed above with reference to FIG. 2, management application 90 may allow customers to use points to obtain benefits other than special buying opportunities. For instance, management application 90 may allow customers to redeem points for cash, prizes, etc. As a non-limiting example of a specific implementation, management application 90 may allow customers to obtain a code that can be redeemed for a discount on an order. In another instance, members who earn a certain number of points may become eligible for free shipping on all of their purchases for a defined time period.

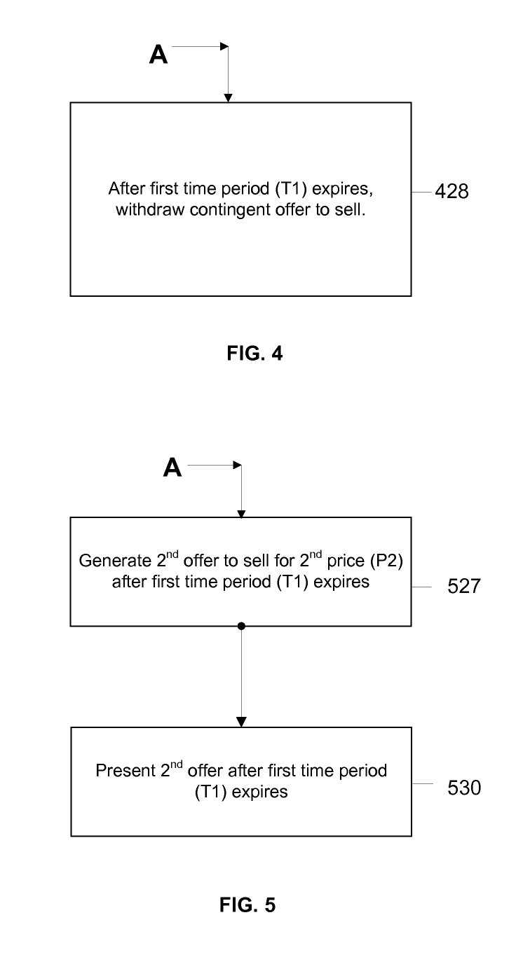

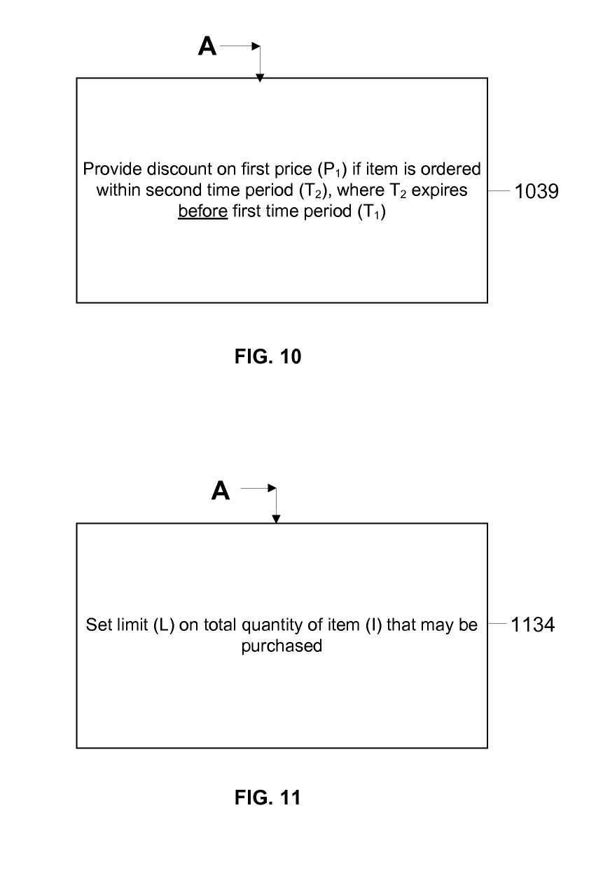

In still other embodiments, management application 90 may use a variety of promotional ideas or “twists” to increase consumer interest and/or participation. For instance, management application 90 may impose a time limit to drive the purchase decision. A non-limiting example is shown in FIG. 4. As seen in that figure (which may be understood as an optional extension of FIG. 3), at step 428, after the first time period expires, management application 90 withdraws the contingent offer to sell. Time limits may be structured and presented in a manner similar to that used by flash sale sites and/or by similar approaches used by Costco™ and/or Sam's Club™. Relatedly, management application 90 may give a discount to customers who order early (or, in the terminology of FIG. 3, within a second time period that expires before the first time period expires), thus providing an additional incentive to act quickly and rewarding customers who wait longer for delivery. This scenario is illustrated in FIG. 10. FIG. 10 may be understood to be an optional portion of a method that includes the steps of FIG. 3 and FIG. 10. Given the context of FIG. 3, at step 1039 in FIG. 10, management application 90 provides a discount on the first price if the good or service is ordered within a second time period, wherein the second time period expires before the first time period expires. It may be noted that the scenario illustrated in FIG. 10 differs from the scenario illustrated in FIG. 5 in that in the FIG. 10 scenario the price is changed (e.g., reduced) where the minimum quantity condition has not necessarily yet been fulfilled and there is still time remaining for it to be fulfilled, whereas in the FIG. 5 scenario the price is changed (e.g., increased) where the minimum quantity condition has been fulfilled (and the time limit for fulfilling it has expired). In sum, time limits may operate such that after the time limit expires, the management application stops selling the item (stops permitting offers to be accepted) (FIG. 4), or such that after a time limit expires, the management application continues to sell the item but at an increased price (in other words, customers who order early are given a discount) (FIGS. 5 and 10).

In addition to incentives based on time limits, incentives may be provided for purchasing in high volume, according to some embodiments. For some offers, if the sale volume reaches certain tiers, management application 90 may reduce the price for everyone, thereby providing another layer of volume discounting. For example, if 100 watches will fit in a convenient shipping container, such as a cardboard box, an offer may present watches for $100 apiece, provided at least 100 units are sold. In addition, if 8 boxes will fit on a pallet, the management application may reduce the price to $95 if 800 units are sold. Furthermore, if 8 pallets will fit in an intermodal container, the management application may reduce the price to $90 if 6400 units are sold. As discussed below, the various embodiments disclosed herein may generally be combined. In that regard, various ways of volume discounting may be combined with various ways of providing time limits. For example, in the above example, if an initial time limit or deadline is set for the selling of the minimum quantity of watches (100 watches), the price may be lowered to $95 or $90 if 800 or 6400 units, respectively, are sold within the initial time limit. Alternatively, the time limit may be lengthened for the sale of the larger quantities, i.e., the price may be lowered to $90 or $95 if 800 or 6400 units, respectively, are sold within a second time limit that is longer than the initial time limit. As another example, if the initial offer presents watches for $100 apiece, provided at least 100 units are sold, within an initial time limit or deadline, then the price may be reduced if the 100 units are sold within a second time limit that is shorter than the first time limit. The various volume discount-time limit scenarios may be expressed generally as follows. With reference to FIG. 3 as context, management application 90 may proffer an offer to sell the good or service at a second (e.g., lower) price, contingent upon (a) a second (e.g., larger) quantity of the good or service being ordered for purchase within the first time period, (b) the first quantity of the good or service being ordered for purchase within a second (e.g., shorter) time period, or (c) a second (e.g., larger) quantity of the good or service being ordered for purchase within a second (e.g., longer) time period.

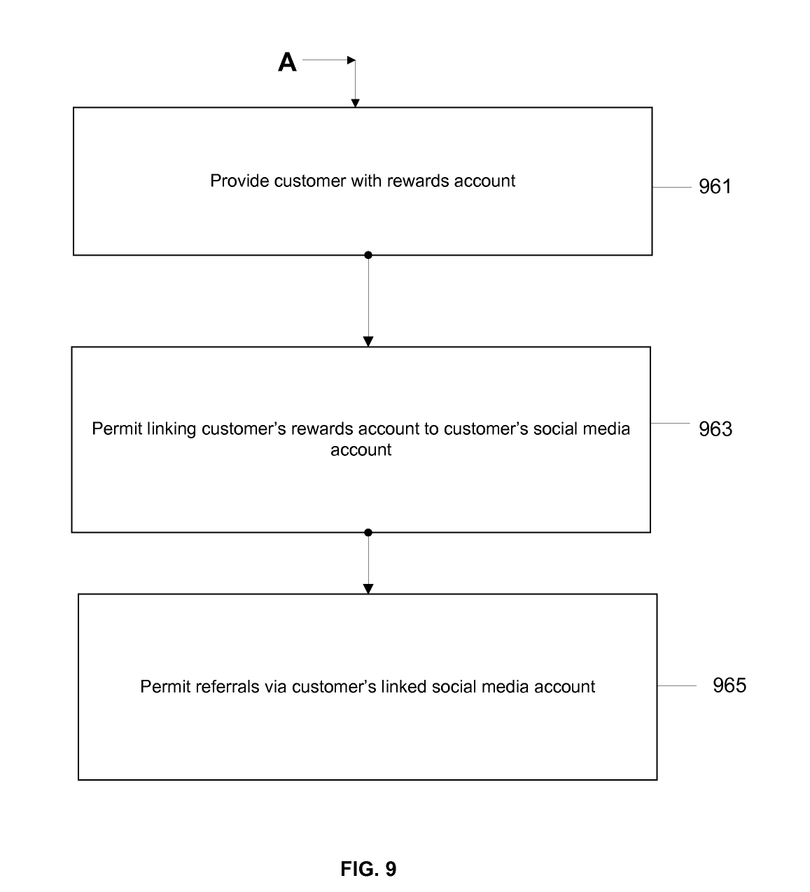

FIG. 9 illustrates an optional social media linking aspect of an example customer reward and ranking system or method, in accordance with some embodiments. FIG. 9 may be understood as an optional portion of a method that includes the steps of FIG. 3 and FIG. 9. As illustrated in the figure, at step 961, management application 90 provides the customer with an account associated with management application 90, which account may be referred to as a “rewards account”. At step 963, management application 90 permits the customer's rewards account to be linked with one or more social media accounts of the customer and, at step 965, permits the customer to refer a referee via the customer's linked social media account. The steps of FIG. 9 may but need not occur prior to any step in FIG. 3. Specific, non-limiting examples of the social media linking aspect are now described. According to some embodiments, management application 90 ties in to all major social media platforms, such as Facebook™, Twitter™, etc. For instance, management application 90 may allow members to connect their accounts on Facebook™, Twitter™, etc. to their account within the management application (“rewards account”). For example, a member may elect to connect to their Twitter account, allowing the member to share the offer they received with their friends and followers or invite a specific friend to participate in the offer. Members also may be able to earn points by sharing offers with others within their social networks.

A small sampling of some of the products that could be sold by management application 90 include, without limitation, furniture, holiday lighting kits for the whole house, hose/sprinkler kits, snow shovels, table saws, sliding miter saws, large mechanics tool chests, high-end lamps, pressure washers, grandfather clocks, fans, complete garage storage system kits, patio heaters, high-end tactical flashlights, paint kits (which may include better and/or more components that conventional paint kits), golf club sets, jewelry, outdoor decor and lighting, garden pond kits, watches, articulating ladders (e.g., like those sold under the Little Giant™ trademark), and many other types of goods. In addition, management application 90 could provide an outlet for new, innovative products that might otherwise be difficult to introduce for retail sale using conventional channels. Management application 90 may also be particularly effective for selling seasonal items. As noted, not only goods but also services may be sold by management application 90.

An additional embodiment, directed to tracking customer referrals, will be discussed with reference to FIG. 13, which illustrates an example method therefor. (It is noted that specific examples of this embodiment have been mentioned above in the discussion of examples of Adam and Bob.) As seen in FIG. 13, at step 1301, management application 90 presents an offer 94 to a recipient, offer 94 having a tracking device 96 that identifies the recipient and that may be forwarded with the offer if the offer is forwarded from the recipient to a referee. The remainder of the steps in this method are optional. Tracking device 96 may be configured to identify the recipient to management application 90 and, upon the recipient forwarding offer 94 to a referee or upon the referee accepting the offer 94 (or taking other action with respect to offer 94, e.g., clicking on a link to visit a website to find out information about the offer), to identify the referee to the management application 90. At step 1311, management application 90 receives this identification data from tracking device 96. At step 1321, management application 90 ascertains whether the referee is included in a customer database such as customer database 92, as indicated by the decision block. If the referee is not included in the customer database, then at step 1331, management application 90 adds information pertaining to the referee to the database. After adding the referee to the database, or if the referee is already included in the database, then at step 1341, management application 90 assigns reward(s) to the recipient and/or referee, based on actions performed by them. Specifically, if the recipient forwards the offer to a referee, management application 90 may assign a reward to the recipient based on the referral; if the recipient forwards the offer to a referee and the referee accepts the offer, management application 90 may assign a reward to the recipient based on the acceptance of the offer (purchase) by the referee; if the recipient forwards the offer to a referee and the referee accepts the offer, management application 90 may assign a reward to the referee based on the referee's acceptance of the offer (purchase). At step 1351, management application 90 may assign a rank to a recipient and/or a referee based on an amount of rewards assigned to the recipient and/or referee, respectively. At step 1361, management application 90 may determine whether the recipient and/or the referee is eligible for a benefit, based on the rank or the amount of rewards assigned to the recipient and/or the referee, respectively. At step 1371, upon determining that the recipient and/or the referee is eligible for a benefit, management application 90 may offer the recipient and/or the referee, respectively, a benefit. Additional aspects that may be included in this embodiment are noted as follows. Offer 94 may be presented by transmission to an electronic device associated with the recipient. Offer 94 may be transmitted via e-mail or as a text message. Tracking device 96 may be a token included in offer 94. The recipient may be a member of a social media site, and management application 90 may be configured to permit the recipient to forward offer 94 to a referee via the recipient's social media site. In this case, tracking device 96 may be a hyperlink with a token embedded therein, the token being included in offer 94.

As an example of the method described above with reference to FIG. 13, a customer may be offered a manicure at a spa at a discount. The customer may not require a manicure, but may refer the offer to his sister who had mentioned that she needed a manicure. A tracking device 96 is included with the offer. When the offer is forwarded to the customer's sister, the sister may click on a link to open a website for the spa. The tracking device 96 may provide information via the website to management application 90, identifying the customer. Management system 90 may add the sister to a customer database, assign rewards to the customer and sister, and accordingly adjust rankings for both the sister and the customer. Management system 90 may offer benefits to the sister and the customer, based on the adjusted rankings of each.

As will be understood from the foregoing description, a customer reward and ranking system or method according to some embodiments may be implemented in conjunction with the following business model. A website is provided for consumers to purchase goods and services on-line. An offer is presented on the website for a good or service at a very low price. The offer is subject to certain conditions. For example, the offer is conditioned upon a certain minimum quantity of the good or service being ordered for purchase; that is, the orders are not consummated until and unless the minimum quantity has been met. The minimum quantity may be determined by the seller based on what is necessary to fill shipping containers and hence reduce seller cost such as to permit sellers to sell at the very low prices which have been set in the offer. The offer may also be subject to a time limit, such that the required minimum quantity must be ordered for purchase by a certain deadline in order for the deals to go through. In view of the conditional nature of the offer, customers place orders on the website but are not charged until the deal goes through. Similarly, the seller may choose not to initiate, or not to complete, manufacture, packing and/or shipping of the item being sold until the deals go through.

Additional aspects may be included in the above business model and in embodiments of a customer rewards and ranking system and method that may be implemented in conjunction therewith. For example, the quantity of the good or service being offered for sale may be limited, such that demand exceeds supply, thus heightening perceived value of the good or service being offered. Another benefit of ensuring adequate or excess demand is to ensure that the item will “sell out” (i.e., all of the units offered for sale will be sold), thus eliminating the need for and cost of excess stock/inventory. The limit set on the quantity of good or service offered for sale may be based on a predetermined estimate/prediction of demand and/or on factors pertaining to production/supply/inventory/price. In this regard, the functional conception of the offer described above may be further revised, reflecting the fact that the offer may be further defined in terms of a limit on the quantity of the good or service being offered for sale. Equation (3) shows this revised and still more complex formulation of the offer.

O=f(I,P1{ . . . PN},T1{ . . . TN},Q1{ . . . QN},L) (3)

where I is the item, that is, the good or service being offered for sale, P1 to PN are the one or more prices at which the item is being offered for sale during different time periods, T1 to TN are the one or more time periods during which the item is being offered for sale, Q1 to QN are the one or more minimum quantities of the item that must be ordered for purchase within respective time periods, and L is the limit on the quantity (i.e., the maximum quantity) of the good or service being offered for sale. In the equation, the curly braces around the expressions “ . . . PN,” “ . . . TN,” and “ . . . QN” indicate that the offer may be a function of one or more prices/times/quantities; it is not necessarily the case that the offer be defined in terms of multiple prices/times/quantities. According to some embodiments, an example customer rewards and ranking system or method may include such a limit L, as shown in FIG. 11, which may be understood to be an optional portion of a method that includes the steps of FIG. 3 and FIG. 11. Given the context of FIG. 3, at step 1134 in FIG. 11, management application 90 sets a limit on the total quantity of the good or service that may be purchased, such that the offer is further contingent upon the offer being accepted before the limit is reached. The limit L may equal or exceed the minimum quantity required for the deal to go through (where the offer is defined by multiple minimum quantities corresponding to multiple time periods, the limit may equal or exceed the highest of the multiple minimum quantities or multiple limits may be set for the different multiple quantities/time periods). For example, in a simple case (single minimum quantity), Q1 could be 100 (of course, where there is a single minimum quantity, Q1 may be referred to as Q), and L could be 100. In this case, the deal goes through for all orders (that is, the orders for the 1^{st} through 100^{th} units) only when the 100^{th} unit is ordered; thereafter, the 101^{st} unit cannot be ordered/purchased because at this point the contingent offer fails because the “limit” condition was not satisfied, that is, the order was not accepted before the limit (100^{th} unit ordered) was reached. Limit L may be set based on an estimate/prediction of demand and/or factors pertaining to production/supply/inventory/price.

Another additional aspect that could be included in the business model and in a customer rewards and ranking system or method implemented in conjunction therewith is that, with regard to the time limit within which the minimum quantity of goods or services must be ordered for the deal to go through, the amount of time remaining within the time limit (in the terminology of FIG. 3, within the first time period) could be indicated to the purchaser. This indication could be provided by management application 90. For example, the amount of time left before the deadline may be shown on a website by a countdown clock or the like. For example, the website through which the management application operates may display a digital countdown, similar to the Home Shopping Network™.

Another additional aspect would be that a display of the good or service being offered for sale could be provided to the purchaser. Again, this display could be provided by management application 90. For example, the website through which the management application operates could provide static images or live video, fed from a camera at the warehouse, shipping docks or elsewhere.

Another additional aspect would be that benefits, including special buying opportunities (offers), that are available to members having a certain rank could also be publicized or made known to individuals, groups or entities who are not eligible to redeem rewards for the benefits and not eligible for the special buying opportunities, for example, even to the general public. Doing so may heighten the perceived value of the benefits and/or encourage greater participation. In this regard, management application 90 may make a benefit or an offer known to profferees other than customers of a certain rank (e.g., first tier) or, correspondingly, other than customers who have been given a certain amount of rewards (e.g., an amount of rewards exceeding the first threshold).

Another additional aspect would be that a bonus award could be given to one who successfully accepts an offer. Again, doing so may heighten the perceived value of the benefits and/or encourage greater participation. In this regard, management application 90 may give a bonus award to a purchaser upon acceptance of an offer by the purchaser. Specific, non-limiting examples are now described. From the business model perspective, it may be understood that bonus award or entertainment features attendant upon a deal “making” may serve to increase interest, enjoyment, and excitement, and hence value to the participant and consequently participation. For instance, a seller may wish to create an offer with the added bonus that, if and when the deal makes, a popular celebrity will get dunked into a dunking tank. According to some embodiments of a customer reward and ranking system, management application 90 may define and present an offer including such a bonus award. For example, the website through which the management application operates may include a live webcam broadcast of the celebrity sitting on the plank and (potentially) getting dunked. The term “digital circus” may be used to refer to event combinations of this general nature.

With further reference to the business model in conjunction with which a customer rewards and ranking system or method may be implemented, some additional challenges may be present in some circumstances. For instance, delivery times could be longer than what consumers are used to, e.g., where the purchased goods are shipped to the consumers directly from a foreign country of origin. To address this, in some embodiments, management application 90 could include an algorithm, based on experience, that allows management application 90 to predict final sale quantity and/or time of offer completion. Management application 90 could then effectively trigger production before the deal completes, to speed up delivery time.

Further, since the business model and the customer rewards and ranking system are new and unknown, in order to generate consumer trust, the website or other medium through which the business model is implemented and via which the management application operates, could be sponsored or endorsed by, or could otherwise operate under, a well known brand name. Marketing and advertising could also be used to generate awareness and drive immediate traffic to the website, etc. Also, to encourage participation, the proprietor (i.e., the individual or organization that owns and/or controls the website, etc. and the management application) may employ various strategies to keep the domestic portion of the shipping costs from being excessive, and to provide for customer service and product returns. In this regard, different strategies may be used for selling and shipping products in different circumstances. For instance, some offers may be made available only after the product has arrived in the purchaser's country. Other offers may sell products that are still situated in a foreign country, or that haven't even been manufactured yet. As another example, an internal warranty system (i.e., based in the purchaser's country) may be provided for larger/pricier items.

With further reference to the business model in conjunction with which a customer rewards and ranking system or method may be implemented, the website/medium through which the management application operates can provide for customer reviews and corporate responses to the customer reviews (e.g., along the lines Tripadvisor.com™. Videos may be made available on YouTube.com™ or other websites, explaining the use, from the perspective of the purchaser, of the system run by the management application, describing products that have been offered/will be offered, etc.

As has been described, the management application implements a rewards and ranking system to reward customers for purchases, referrals, etc., where the reward may take the form of offers to purchase goods or services from a website or other benefits. An individual may gain points worth cash or prizes, based on how much the individual buys (or has others buy through referrals). Higher ranking for a customer may result in the management application presenting better or more prized offers or other benefits to that customer and/or may result in offers being made available to higher ranked customers earlier than they are made available to customers with lower rankings. As the management application may sell only limited quantities of a given item at a given price through the website, the “right to buy” those offerings will be valuable.

In some embodiments, the management application gives individuals the right to buy a product at a certain price, based upon a ranking system of how much the individual has bought in the past. Thus, the management application may give the individual the right to future product offerings, based on how much the individual has bought in the past.

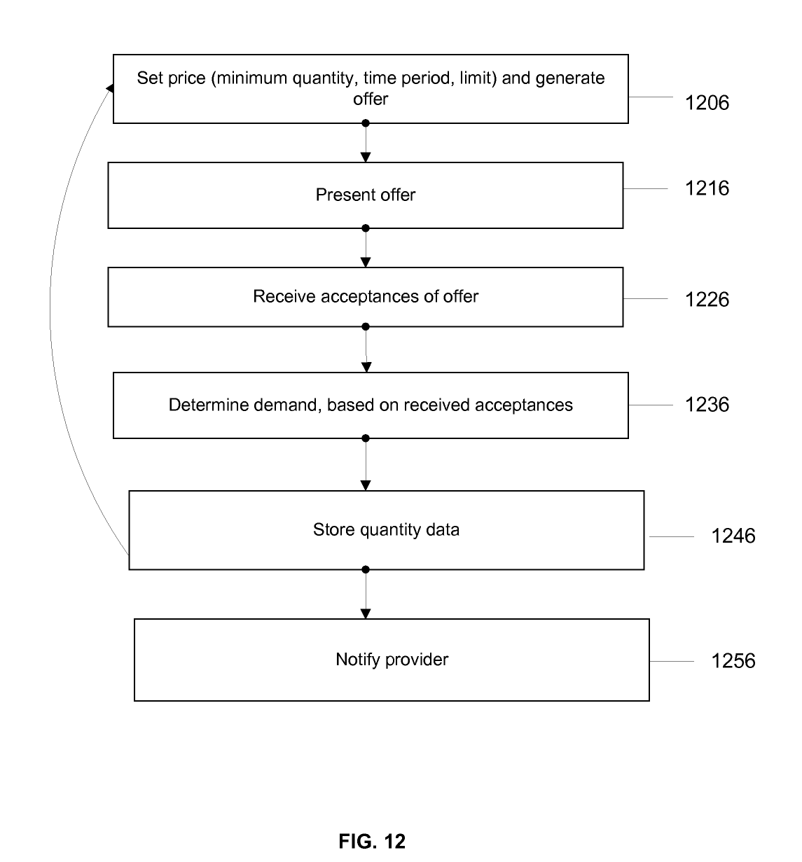

According to some further embodiments, systems and methods for advance determination of customer demand are provided. Such a system may involve offer generation module 54, offer presentation module 56, offer completion module 58, and demand determination module 67. A method for advance determination of customer demand is illustrated in FIG. 12. As seen in the figure, at step 1206, offer generation module 54 sets a price for an item (good or service) to be offered for sale and generates an offer to sell the item for the set price. (The parenthetical reference in the figure to setting minimum quantity, time period and limit refers to optional aspects of step 1206, which will be discussed below.) At step 1216, offer presentation module 56 presents the generated offer to one or more recipients. At step 1226, offer completion module 58 receives acceptances of the offer from recipients or referees to whom the offer was transferred by respective recipients. At step 1236, demand determination module 67 determines a consumer demand, based on the received acceptances. Each of the acceptances may be an order for purchase of a specified quantity of the item. The remainder of the steps of this method are optional. With respect to step 1236, demand determination module 67 may determine the quantity of the item ordered for purchase, based on the received acceptances, and may determine the demand, based on the determined quantity of the item ordered for purchase. At step 1246, demand determination module 67 may cause to be stored a datum indicative of the quantity of the item ordered for purchase. Offer generation module 54 may use this stored datum in setting a subsequent price of the item in generating a subsequent offer to sell the item, as illustrated by the feedback loop from step 1246 to step 1206. At step 1256, demand determination module 67 may transmit to a provider of the item a notification. (The term “provider” is to be understood in a broad sense, as referring to any or all of manufacturer, supplier, seller, etc.) The notification may inform the provider of the determined demand. In addition or alternatively, the notification may instruct the provider to commence or complete production of the item, e.g., based on the determined demand. With reference to the noted parenthetical text (optional portion) shown in step 1206 in the figure, offer generation module 54 may set a price, a minimum quantity and a time period for an item to be offered for sale and generate an offer to sell the item for the set price during the time period, contingent upon the set minimum quantity of the item being ordered for purchase within the time period. In this case, certain further aspects may be included in the method. One such further aspect is that demand determination module 67 may determine whether the set minimum quantity of the item has been ordered for purchase within the time period and, upon determining that the set minimum quantity of the item has been ordered for purchase within the time period, may transmit to a provider of the item a notification informing the provider of the determined demand and/or instructing the provider to commence or complete production of the item, as with the previously discussed notification. Another such further aspect is that offer generation module 54 may set the minimum quantity as a function of the price, set the price as a function of the minimum quantity, and/or set the minimum quantity based on an estimate/predication of consumer demand for the item. Another such further aspect is that offer completion module 58 may, after the time period has expired, cause to be stored a datum indicative of the quantity of the item ordered for purchase during the time period, and offer generation module 54 may use the stored datum in setting a subsequent minimum quantity and/or a subsequent price of the item in generating a subsequent offer to sell the item during a subsequent time period. With further reference to the noted parenthetical text (optional portion) shown in step 1206 in the figure, offer generation module 54 may set a minimum quantity—the offer being contingent upon the set minimum quantity of the item being ordered for purchase—but not a time period. Still further, offer generation module 54 may set a limit (L) on the quantity permitted to be sold, as discussed above with reference to Equation (3). The limit may be set, based on, e.g., an estimated demand, a previously determined demand, a predicted demand (discussed below), and/or a price.

It should be understood that the advance determination of consumer demand, described above with reference to FIG. 12 may readily be combined with other aspects or embodiments disclosed herein, such as the customer rewards and ranking systems and methods. In this regard, it is noted that the advance determination of consumer demand is applicable, inter alia, not only in situations where there is only a single quantity (Q) and time period (T) (as discussed above with reference to Equation (1)), but also in cases where there are multiple quantities (Q1, QN) corresponding to multiple time periods (T1, . . . , TN) (as discussed above with reference to Equation (2), although, as noted, it is not necessary for a minimum quantity (Q) to be involved at all in order to carry out advance determination of consumer demand. Where multiple quantities are involved, the determination of demand/quantity ordered, storing of quantity data, and notification of providers (steps 1236, 1246, and 1256) may be performed for each successive quantity/time period, and quantity data from a given time period may be fed back for use by offer generation module 54 in a subsequent time period. Thus, e.g., manufacturers/suppliers/sellers could be notified, as explained above, each time a minimum quantity (e.g., Q1, Q2, etc.) has been ordered.

By virtue of the systems and methods described above with reference to FIG. 12, advance knowledge of the amount of the item to be sold can be provided to the manufacturer/supplier/seller, such that the problem of excess (unsellable) production or excess inventory can be avoided or reduced. For example, the manufacturer can wait to commence production, or at least refrain from completing production, until the manufacturer knows how much of the item is to be sold. Similarly, the supplier/seller can wait to order/obtain some or all inventory until after being informed of the amount of the item to be sold. In this way, production and supply planning can be markedly improved, and costs can be reduced for manufacturer, supplier, seller and consumer.

As an example, in the case where an offer contingent on a minimum quantity being ordered for purchase is employed, after the first minimum quantity of the good or service has been ordered, management application 90 may notify a provider (e.g., manufacturer, supplier or seller) of the good or service to commence or complete production of the first quantity of the good or service. Under this arrangement, production of the first minimum quantity of the good or service may have not been commenced or not been completed prior to the first minimum quantity of the good or service having been ordered. This effective triggering of production, or of completion of production, may be performed by demand determination module 67, which may be configured to notify a provider of the good or service to commence or complete production of a given quantity of the good or service. Demand determination module 67 may trigger events such as the following: manufacture of the product; pre-packing and pre-labeling of cartons for consumer delivery; shipping of container(s) to seller's logistics partner in closer proximity to intended customer; shipping of packages to customers, and charging of customers' credit cards. As an alternative to advance determination of consumer demand as described above, (advance) prediction of consumer demand is also possible, e.g., management application 90 could include an algorithm, based on experience, that allows management application 90 to predict a(n expected) final sale quantity, as discussed above.

While the advance determination of demand may be thought more readily applicable to the case of goods than services, it will be understood that it may also apply to services, and also to preparatory/ancillary/etc. activities/production associated with services.

In light of the principles and example embodiments described and illustrated herein, it will be recognized that the example embodiments can be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered. Similarly, this disclosure describes one or more embodiments wherein various operations are performed by certain systems, applications, module, components, etc. In alternative embodiments, however, those operations could be performed by different components. Also, items such as applications, module, components, etc. may be implemented as software constructs stored in a machine accessible storage medium, such as an optical disk, a hard disk drive, etc., and those constructs may take the form of applications, programs, subroutines, instructions, objects, methods, classes, or any other suitable form of control logic; such items may also be implemented as firmware or hardware, or as any combination of software, firmware and hardware, or any combination of any two of software, firmware and hardware.

Further, each of the method embodiments set forth above, including all combinations of method embodiments, may also be instantiated as an article of manufacture embodiment, wherein an article of manufacture comprises a non-transitory machine-accessible medium containing instructions, the instructions comprising a management application, such as management application 90, wherein the instructions, when executed by the machine, cause the machine to perform the respective method.

This disclosure also describes various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

1.-104. (canceled)

105. An article of manufacture comprising a non-transitory machine-readable medium comprising instructions that, if executed, enable a processor-based system to:
rank a customer in one of multiple tiers of customers based on an amount of rewards assigned to the customer, the multiple tiers comprising at least a first tier and a second tier, the first tier comprising customers having a greater amount of rewards, and the second tier comprising customers having a lesser amount of rewards;
present a first offer during a first time period exclusively to customers ranked in the first tier; and
restrict acceptance of the first offer during the first time period to (a) customers ranked in the first tier and (b) referees referred by any customer ranked in the first tier.

106. The article of manufacture of claim 105, wherein the instructions, if executed, further enable the processor-based system to assign a reward to (a) the customer, based on an action performed by the customer or performed by a referee referred by the customer, or (b) a referee referred by the customer, based on an action performed by the referee referred by the customer.

107. The article of manufacture of claim 106,
wherein the action performed by the customer is (a) a purchase or (b) a referral of a referee; and
wherein the action performed by the referee referred by the customer is a purchase.

108. The article of manufacture of claim 105, wherein the instructions, if executed, further enable the processor-based system to generate the first offer, the first offer comprising an offer to sell a good or service for a first price during the first time period, and the first offer being contingent upon a first quantity of the good or service being ordered for purchase within the first time period.

109. The article of manufacture of claim 108, wherein the instructions, if executed, further enable the processor-based system to discount the first price if the first quantity of the good or service is ordered for purchase within a second time period, wherein the second time period expires before the first time period expires.

110. The article of manufacture of claim 108, wherein the instructions, if executed, further enable the processor-based system to:
generate a second offer, the second offer comprising an offer to sell the good or service for the first price during a second time period, the second time period being subsequent to the first time period, and the second offer being contingent upon the first quantity of the good or service being ordered for purchase within the second time period;
present the second offer during the second time period, if the first quantity of the good or service was not ordered for purchase within the first time period, exclusively to customers ranked in the first or second tier; and
restrict acceptance of the second offer during the second time period to (i) customers ranked in the first or second tier and (ii) referees referred by any customer ranked in the first or second tier.

111. The article of manufacture of claim 110, wherein the instructions, if executed, further enable the processor-based system to:
generate a third offer, the third offer comprising an offer to sell the good or service for the first price after expiration of the second time period, and the third offer being contingent upon the first quantity of the good or service being ordered for purchase;
present the third offer to one or more recipients if the first quantity of the good or service was not ordered for purchase within the second time period; and
permit the third offer to be accepted after expiration of the second time period by (i) customers ranked in the first or second tier, (ii) referees referred by any customer ranked in the first or second tier, and (iii) recipients other than (A) customers ranked in the first or second tier and (B) referees referred by any customer ranked in the first or second tier.

112. The article of manufacture of claim 108, wherein the instructions, if executed, further enable the processor-based system to:
generate a second offer, the second offer comprising an offer to sell the good or service for a second price after expiration of the first time period; and
present the second offer after expiration of the first time period to one or more recipients.

113. The article of manufacture of claim 105, wherein the instructions, if executed, further enable the processor-based system to:
generate a second offer, the second offer comprising an offer to sell the good or service for a second price, and the second offer being contingent upon (a) a second quantity of the good or service being ordered for purchase within the first time period, (b) the first quantity of the good or service being ordered for purchase within a second time period, or (c) a second quantity of the good or service being ordered for purchase within a second time period; and
present the second offer.

114. The article of manufacture of claim 105, wherein the amount of rewards assigned to the customer comprises a number of points assigned to the customer, the first tier comprising customers having a number of points equal to or greater than a threshold and the second tier comprising customers having a number of points less than the threshold.

115. The article of manufacture of claim 105, wherein the instructions, if executed, further enable the processor-based system to:
assign the customer a rewards account;
permit the rewards account of the customer to be linked with a social media account of the customer; and
permit a referee to be referred by the customer via the social media account of the customer.

116. The article of manufacture of claim 108, wherein the instructions, if executed, further enable the processor-based system to:
set a limit on a total quantity of the good or service that may be purchased, such that the first offer is further contingent upon the first offer being accepted before the limit is reached.

117. The article of manufacture of claim 105, wherein the instructions, if executed, further enable the processor-based system to:
indicate an amount of time remaining within the first time period.

118. The article of manufacture of claim 105, wherein the instructions, if executed, further enable the processor-based system to:
cause information pertaining to the first offer to be transmitted to recipients other than customers ranked in the first tier.

119. The article of manufacture of claim 105, wherein the instructions, if executed, further enable the processor-based system to:
redeem a reward for a benefit other than an offer to buy a good or service.

120. The article of manufacture of claim 105, wherein the instructions, if executed, further enable the processor-based system to:
assign an award to a customer or referee, upon acceptance of the first offer by the customer or referee, respectively.

121. The article of manufacture of claim 108, wherein the instructions, if executed, further enable the processor-based system to:
provide a display of the good or service being offered for sale.

122. The article of manufacture of claim 105, wherein the first offer is presented by transmission to an electronic device.

123. A method, comprising:
ranking, using one or more processors, a customer in one of multiple tiers of customers based on an amount of rewards assigned to the customer, the multiple tiers comprising at least a first tier and a second tier, the first tier comprising customers having a greater amount of rewards, and the second tier comprising customers having a lesser amount of rewards;
presenting a first offer during a first time period exclusively to customers ranked in the first tier; and
restricting acceptance of the first offer during the first time period to (a) customers ranked in the first tier and (b) referees referred by any customer ranked in the first tier.

124. The method of claim 123, further comprising assigning a reward to (a) the customer, based on an action performed by the customer or performed by a referee referred by the customer, or (b) a referee referred by the customer, based on an action performed by the referee referred by the customer.

125. The method of claim 124,
wherein the action performed by the customer is (a) a purchase or (b) a referral of a referee; and
wherein the action performed by the referee referred by the customer is a purchase.

126. The method of claim 123, further comprising generating the first offer, the first offer comprising an offer to sell a good or service for a first price during the first time period, and the first offer being contingent upon a first quantity of the good or service being ordered for purchase within the first time period.

127. The method of claim 126, further comprising discounting the first price if the first quantity of the good or service is ordered for purchase within a second time period, wherein the second time period expires before the first time period expires.

128. The method of claim 126, further comprising:
generating a second offer, the second offer comprising an offer to sell the good or service for the first price during a second time period, the second time period being subsequent to the first time period, and the second offer being contingent upon the first quantity of the good or service being ordered for purchase within the second time period;
presenting the second offer during the second time period, if the first quantity of the good or service was not ordered for purchase within the first time period, exclusively to customers ranked in the first or second tier; and
restricting acceptance of the second offer during the second time period to (i) customers ranked in the first or second tier and (ii) referees referred by any customer ranked in the first or second tier.

129. The method of claim 128, further comprising:
generating a third offer, the third offer comprising an offer to sell the good or service for the first price after expiration of the second time period, and the third offer being contingent upon the first quantity of the good or service being ordered for purchase;
presenting the third offer to one or more recipients if the first quantity of the good or service was not ordered for purchase within the second time period; and
permitting the third offer to be accepted after expiration of the second time period by (i) customers ranked in the first or second tier, (ii) referees referred by any customer ranked in the first or second tier, and (iii) recipients other than (A) customers ranked in the first or second tier and (B) referees referred by any customer ranked in the first or second tier.

130. The method of claim 126, further comprising:
generating a second offer, the second offer comprising an offer to sell the good or service for a second price after expiration of the first time period; and
presenting the second offer after expiration of the first time period to one or more recipients.

131. The method of claim 126, further comprising:
generating a second offer, the second offer comprising an offer to sell the good or service for a second price, and the second offer being contingent upon (a) a second quantity of the good or service being ordered for purchase within the first time period, (b) the first quantity of the good or service being ordered for purchase within a second time period, or (c) a second quantity of the good or service being ordered for purchase within a second time period; and
presenting the second offer.

132. The method of claim 123, wherein the amount of rewards assigned to the customer comprises a number of points assigned to the customer, the first tier comprising customers having a number of points equal to or greater than a threshold and the second tier comprising customers having a number of points less than the threshold.

133. The method of claim 123, further comprising:
assigning the customer a rewards account;
permitting the rewards account of the customer to be linked with a social media account of the customer; and
permitting a referee to be referred by the customer via the social media account of the customer.

134. The method of claim 126, further comprising:
setting a limit on a total quantity of the good or service that may be purchased, such that the first offer is further contingent upon the first offer being accepted before the limit is reached.

135. The method of claim 123, further comprising:
indicating an amount of time remaining within the first time period.

136. The method of claim 123, further comprising:
causing information pertaining to the first offer to be transmitted to recipients other than customers ranked in the first tier.

137. The method of claim 123, further comprising:
redeeming a reward for a benefit other than an offer to buy a good or service.

138. The method of claim 123, further comprising:
assigning an award to a customer or referee, upon acceptance of the first offer by the customer or referee, respectively.

139. The method of claim 126, further comprising:
providing a display of the good or service being offered for sale.

140. The method of claim 123, wherein the first offer is presented by transmission to an electronic device.

141. A system, comprising:
a server, the server comprising:
one or more processors;
memory coupled to the one or more processors, the memory storing executable instructions that when executed by the one or more processors, cause the one or more processors to:
rank a customer in one of multiple tiers of customers based on an amount of rewards assigned to the customer, the multiple tiers comprising at least a first tier and a second tier, the first tier comprising customers having a greater amount of rewards, and the second tier comprising customers having a lesser amount of rewards;
present a first offer during a first time period exclusively to customers ranked in the first tier; and
restrict acceptance of the first offer during the first time period to (a) customers ranked in the first tier and (b) referees referred by any customer ranked in the first tier.

142. The system of claim 141, wherein the instructions, when executed by the one or more processors, further cause the one or more processors to assign a reward to (a) the customer, based on an action performed by the customer or performed by a referee referred by the customer, or (b) a referee referred by the customer, based on an action performed by the referee referred by the customer.

143. The system of claim 142,
wherein the action performed by the customer is (a) a purchase or (b) a referral of a referee; and
wherein the action performed by the referee referred by the customer is a purchase.

144. The system of claim 141, wherein the instructions, when executed by the one or more processors, further cause the one or more processors to generate the first offer, the first offer comprising an offer to sell a good or service for a first price during the first time period, and the first offer being contingent upon a first quantity of the good or service being ordered for purchase within the first time period.

145. The system of claim 144, wherein the instructions, when executed by the one or more processors, further cause the one or more processors to discount the first price if the first quantity of the good or service is ordered for purchase within a second time period, wherein the second time period expires before the first time period expires.

146. The system of claim 144, wherein the instructions, when executed by the one or more processors, further cause the one or more processors to:
generate a second offer, the second offer comprising an offer to sell the good or service for the first price during a second time period, the second time period being subsequent to the first time period, and the second offer being contingent upon the first quantity of the good or service being ordered for purchase within the second time period;
present the second offer during the second time period, if the first quantity of the good or service was not ordered for purchase within the first time period, exclusively to customers ranked in the first or second tier; and
restrict acceptance of the second offer during the second time period to (i) customers ranked in the first or second tier and (ii) referees referred by any customer ranked in the first or second tier.

147. The system of claim 146, wherein the instructions, when executed by the one or more processors, further cause the one or more processors to:
generate a third offer, the third offer comprising an offer to sell the good or service for the first price after expiration of the second time period, and the third offer being contingent upon the first quantity of the good or service being ordered for purchase;
present the third offer to one or more recipients if the first quantity of the good or service was not ordered for purchase within the second time period; and
permit the third offer to be accepted after expiration of the second time period by (i) customers ranked in the first or second tier, (ii) referees referred by any customer ranked in the first or second tier, and (iii) recipients other than (A) customers ranked in the first or second tier and (B) referees referred by any customer ranked in the first or second tier.

148. The system of claim 144, wherein the instructions, when executed by the one or more processors, further cause the one or more processors to:
generate a second offer, the second offer comprising an offer to sell the good or service for a second price after expiration of the first time period; and
present the second offer after expiration of the first time period to one or more recipients.

149. The system of claim 144, wherein the instructions, when executed by the one or more processors, further cause the one or more processors to:
generate a second offer, the second offer comprising an offer to sell the good or service for a second price, and the second offer being contingent upon (a) a second quantity of the good or service being ordered for purchase within the first time period, (b) the first quantity of the good or service being ordered for purchase within a second time period, or (c) a second quantity of the good or service being ordered for purchase within a second time period; and
present the second offer.

150. The system of claim 141, wherein the amount of rewards assigned to the customer comprises a number of points assigned to the customer, the first tier comprising customers having a number of points equal to or greater than a threshold and the second tier comprising customers having a number of points less than the threshold.

151. The system of claim 141, wherein the instructions, when executed by the one or more processors, further cause the one or more processors to:
assign the customer a rewards account;
permit the rewards account of the customer to be linked with a social media account of the customer; and
permit a referee to be referred by the customer via the social media account of the customer.

152. The system of claim 144, wherein the instructions, when executed by the one or more processors, further cause the one or more processors to set a limit on a total quantity of the good or service that may be purchased, such that the first offer is further contingent upon the first offer being accepted before the limit is reached.

153. The system of claim 141, wherein the instructions, when executed by the one or more processors, further cause the one or more processors to indicate an amount of time remaining within the first time period.

154. The system of claim 141, wherein the instructions, when executed by the one or more processors, further cause the one or more processors to cause information pertaining to the first offer to be transmitted to recipients other than customers ranked in the first tier.

155. The system of claim 141, wherein the instructions, when executed by the one or more processors, further cause the one or more processors to redeem a reward for a benefit other than an offer to buy a good or service.

156. The system of claim 141, wherein the instructions, when executed by the one or more processors, further cause the one or more processors to assign an award to a customer or referee, upon acceptance of the first offer by the customer or referee, respectively.

157. The system of claim 144, wherein the instructions, when executed by the one or more processors, further cause the one or more processors to provide a display of the good or service being offered for sale.

158. The system of claim 141, further comprising:
a data processing system communicatively linked to the server.

159. The system of claim 141, wherein the first offer is presented by transmission to an electronic device.
